(19) United States
(12) Patent Application Publication
(10) Pub. No.: US 2026/0069084 A1
(43) Pub. Date: Mar. 12, 2026

(54) COFFEE GRINDING MACHINE WITH BURR ALIGNMENT SYSTEM AND ASSOCIATED METHOD

(71) Applicant: LA MARZOCCO S.R.L., SCARPERIA E SAN PIERO (IT)

(72) Inventors: Riccardo GATTI, SCARPERIA E SAN PIERO (IT); Riccardo MARCHI, SCARPERIA E SAN PIERO (IT); Marco BECCASTRINI, SCARPERIA E SAN PIERO (IT)

(21) Appl. No.: 19/101,821

(22) PCT Filed: Aug. 10, 2023
(86) PCT No.: PCT/IB2023/058082

§ 371 Date: Feb. 6, 2025

(30) Foreign Application Priority Data
Aug. 10, 2022 (IT) 102022000017139

(51) Int. Cl. A47J 42/20; A47J 42/16; A47J 42/18

(52) U.S. Cl. CPC A47J 42/20; A47J 42/16; A47J 42/18

(57) ABSTRACT

A coffee grinding machine is described, said machine comprising: a first burr; a motor configured to rotate the first burr about a rotation axis; a second burr configured to cooperate with the first burr for grinding coffee beans, wherein the second burr comprises a second surface which, preferably, extends substantially along the outer edge of the second burr, namely in the vicinity of the outer edge of the first burr; a grinder-holder body which can be locked to the second burr, wherein the grinder-holder body comprises a first surface at least partially facing the second surface and cooperating therewith, wherein either one of the first surface and the second surface is a spherical surface, wherein the other one of the first surface and the second surface is a spherical surface, and wherein the first surface and the second surface cooperate with each other so as to suitably orient the first burr with respect to the second burr, before locking the second burr to the grinder-holder body.

### TECHNICAL SECTOR

The present invention relates to a machine for grinding coffee beans. The machine for grinding coffee beans may be a separate machine or may be incorporated in a machine for the production of coffee-based beverages. Such a machine is also known simply as a “coffee grinding machine”, “coffee grinder” or “mill”.

More particularly, the present invention relates to a coffee grinding machine in which grinding of the coffee beans is performed, at least partially, by means of flat burrs. Even more particularly, the present invention relates to a coffee grinding machine with a system for aligning the burrs, namely for making them parallel, and to a method for aligning, namely making parallel, the burrs of a flat-burr coffee grinding machine.

### PRIOR ART

As is known, for the preparation of an espresso coffee, a certain amount of ground coffee, usually called a dose, is used. A dose may be a single, double or multiple dose. The dose of ground coffee is filled inside a filter, typically in the form of a cup which is open at the top and has a bottom with micro-perforations. Typically, the dose of coffee is pressed inside the filter so as to form a puck of coffee powder. The filter is in turn supported by a filter holder which is configured to be removable engaged with a dispensing unit of an espresso coffee machine. The espresso coffee is obtained by passing hot water under pressure through the puck of coffee powder.

The coffee powder is obtained by means of a coffee grinding machine. In a known coffee grinding machine, the coffee beans are ground by making them pass through grinding members. Grinding members of the flat, conical or mixed type are known. Typically, the grinding members of a coffee grinding machine comprise a fixed member and a member rotating with respect to the fixed member. For example, in a coffee grinding machine with flat burrs, one burr remains at a standstill, i.e. stationary, while the other burr is rotated by a motor. Some coffee grinding machines are able to modify the distance between the burrs in order to vary the particle size of the coffee powder.

U.S. Pat. No. 4,037,798 A describes a machine with flat grinders for milling cereals.

### SUMMARY OF THE INVENTION

According to the Applicant, a manufacturer of coffee grinding machines (both with flat burrs and with conical burrs) has the main objective of obtaining a particle size which is repeatable and constant over time, characterized by a dominant curve which is as limited as possible. This, with the aim of obtaining a water exchange area which is similar for all the grains of powder and therefore a similar solute extraction response for the majority of the granules.

The Applicant has considered that, in order to achieve this aim, the alignment of the burrs has a role of primary importance. In fact, if the burrs are aligned, the powder outlet opening has the same height along the entire perimeter of the two burrs. On the other hand, if the burrs are not aligned, the outlet opening has a different height and the particle size of the powder is also different.

Moreover, the Applicant has considered that the general stability of the kinematic mechanical system during operation is also of great importance, including during the necessary steps for adjusting the particle size.

The Applicant has observed that, when the alignment of the burrs is not optimal, some extremely fine grain types cannot be obtained. For example, those particle sizes suitable for the extraction of Turkish coffee cannot be obtained. In any case, a non-optimum particle size results in a reduction in the quality of the beverage obtained.

The Applicant has considered that the machines with flat burrs, owing to their configuration, require a very precise horizontal alignment. In fact, the cutting edges extend along a horizontal component, together with a grinding flow direction which extends radially. In other words, it is preferable that the flat burrs should be perfectly parallel to each other.

The Applicant has noted that the stationary upper millstone 18 of the cereal milling machine described in U.S. Pat. No. 4,037,798 A is constrained to the cylindrical container 10 and does not have degrees of freedom, namely has a position which is rigidly fixed with respect to the cylindrical container 10. The lower rotatable millstone is instead elastically pivotable and its position is dynamically adapted. This solution does not ensure precise alignment of the millstones.

According to the present invention the problem of the precise alignment of the flat burrs in a coffee grinding machine is solved by the shaped coupling between the grinder-holder body and the fixed burr. The shaped coupling is preferably a coupling realized by means of a curved surface, for example spherical or substantially spherical surface.

According to a first aspect the present invention provides a coffee grinding machine with flat burrs, comprising:
a first burr;
a motor configured to rotate the first burr about a rotation axis;
a second burr configured to cooperate with the first burr for grinding coffee beans, wherein the second burr comprises a second surface;
a grinder-holder body which can be locked to the second burr, wherein the grinder-holder body comprises a first surface at least partially facing the second surface and cooperating therewith,
wherein either one of the first surface and the second surface is a spherical surface,
wherein the other one of the first surface and the second surface is a spherical surface, or comprises a conical surface, or comprises a serrated surface, or comprises a deformable element, and
wherein the first surface and the second surface cooperate with each other so as to suitably orient the first burr with respect to the second burr, before locking the second burr to the grinder-holder body.

According to embodiments, the second surface extends substantially along the outer edge of the second burr, namely in the vicinity of the outer edge of the first burr.

According to embodiments, the first surface is a spherical surface and the second surface is a spherical surface such that there is surface contact between the first surface and the second surface.

According to embodiments, the second surface is a spherical surface and the first surface is a conical surface or the second surface is a conical surface and the first surface is a spherical surface, so that contact is provided along a line between the first surface and the second surface.

According to embodiments, the first surface is a serrated first surface and the second surface is a spherical surface so that contact along one or more lines is provided between the first surface and the second surface.

According to embodiments, the first surface comprises a deformable element and the second surface is a spherical surface so that elastic contact is provided between the grinder-holder body and the second burr.

According to embodiments, the grinder-holder body can be releasably associated with the second burr by means of connection members, for example clamping screws.

According to embodiments, the coffee-grinding machine also comprises elements which allow partial support of the connection members.

According to embodiments, said elements comprise conical spring washers or conical Schnorr® type safety washers.

According to another aspect a method for orienting relative to each other the burrs in a flat-burr coffee grinding machine is provided, the method comprising:
providing a coffee grinding machine comprising:
a first rotatable burr;
a second burr configured to cooperate with the first burr for grinding coffee beans, wherein the second burr comprises a second surface;
a grinder-holder body which can be releasably associated with the second burr, wherein the grinder-holder body comprises a first surface at least partially facing the second surface and cooperating therewith,
wherein either one of the first surface and the second surface is a spherical surface, and wherein the other one of the first surface and the second surface is a spherical surface, or comprises a conical surface, or comprises a serrated surface, or comprises a deformable element,
orienting the second burr with respect to the first burr and
locking the second burr to the grinder-holder body, wherein the orienting step comprises moving relative to each other the second burr and the grinder-holder body along the first surface and the second surface, and the step for releasably associating them is performed after the orienting step.

According to embodiments, the second surface extends substantially along the outer edge of the second burr, namely in the vicinity of the outer edge of the first burr.

According to embodiments, the orienting step comprises orienting the second burr with respect to the first burr so that the first burr is parallel to the second burr.

According to embodiments, the facing curved surfaces comprise spherical surfaces.

The first burr may comprise a first planar surface on an outer rim thereof, and the second burr may comprise a second planar surface on an outer rim thereof and wherein the orienting step comprises the step of moving the second burr closer to the first burr so that the first planar surface and the second planar surface are aligned with each other.

According to embodiments, the second burr is releasably locked to the grinder-holder body after the first planar surface and the second planar surface are arranged parallel to each other.

According to embodiments, the second burr is releasably locked to the grinder-holder body by means of screws and, optionally, conical spring washers or Schnorr® type safety washers.

### BRIEF DESCRIPTION OF THE DRAWINGS

A detailed description of the invention now follows, being provided purely by way of a non-limiting example, to be read with reference to attached figures in which:

FIG. 1.1 is a schematic view of a coffee grinding machine with flat burrs according to an embodiment of the present invention;

FIG. 1.2 is a longitudinally sectioned view of the machine shown in FIG. 1.1;

FIG. 2 is a schematic axonometric view, on a larger scale, of the burrs of the machine shown in FIG. 1.2;

FIG. 3 is a longitudinal sectioned view, on a larger scale, of the burrs of the machine shown in FIG. 1.2;

FIG. 4 is an exploded view of the detail of the burr assembly shown in FIG. 3;

FIGS. 5 and 6 are two exploded cross-sectional views of the burr assembly;

FIG. 7.1 and 7.2 are views, on a larger scale, of two portions of the coupling between fixed burr and grinder holder with double spherical contact;

FIG. 8.1 and 8.2 are views, on a larger scale, of two portions of the coupling between fixed burr and grinder holder with spherical/conical coupling;

FIG. 9.1 and 9.2 are views, on a larger scale, of two portions of the coupling between fixed burr and grinder holder with a serrated surface and a spherical surface; and

FIG. 10.1 and 10.2 are views, on a larger scale, of two portions of the coupling between fixed burr and grinder holder with a spherical surface and a deformable element.

### DETAILED DESCRIPTION

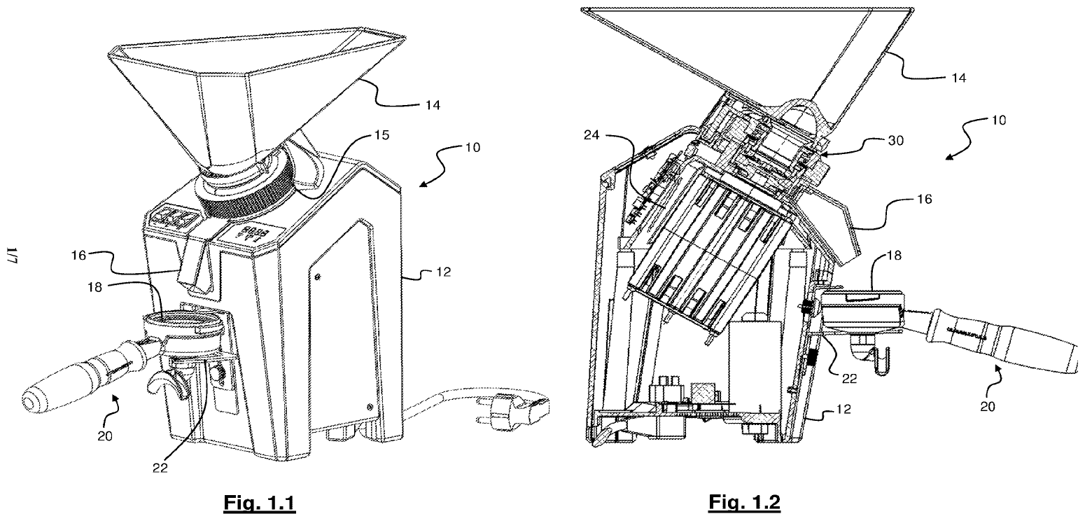

FIG. 1.1 and 1.2 show a coffee grinding machine according to an example of embodiment of the present invention. Obviously, the coffee grinding machine according to the invention may assume a form totally different from that show without thereby departing from the scope of protection of the present invention.

The machine 10 comprise a machine body 12 which contains the main components, including a grinding chamber with a burr assembly 30. Typically the machine 10 comprises a hopper 14 in its top part. The hopper 14 is configured to contain the coffee beans to be ground and allow the coffee beans to reach the grinding chamber and the burr assembly 30.

The machine 10 may also comprise a device 15 for adjusting the fineness of the ground powder, for example a knurled ring nut as shown in FIG. 1.1.

The machine 10 also comprises an outlet duct 16 for directing the ground coffee towards the filter 18 which is in turn supported by a filter holder 20. Advantageously there may be provided a support 22 for supporting the filter holder 20 during filling of the filter 18 with the ground coffee powder. The support 22 may be adjustable heightwise, In FIG. 1.1 also visible are pushbuttons 26 for operating the coffee grinding machine, as well as LEDs (or a display) for showing the status of the machine 10.

FIG. 1.2 shows a longitudinally sectioned view of the machine according to FIG. 1.1. In addition to the components already mentioned, it shows the burr assembly 30 and an electric motor 24 for rotation of one burr with respect to the other one.

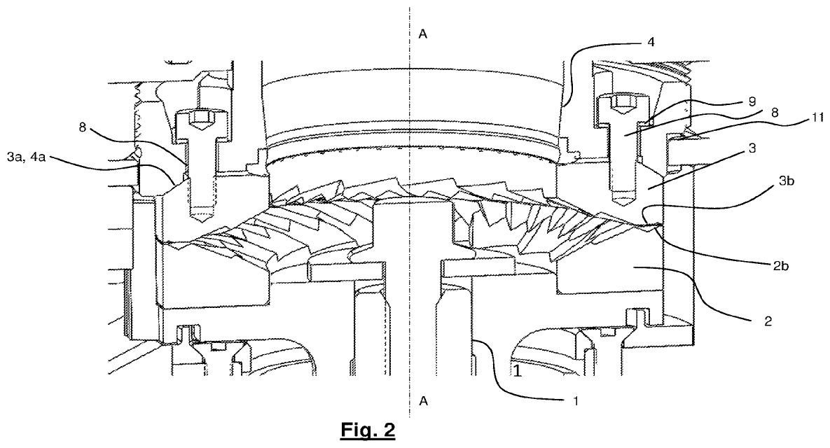

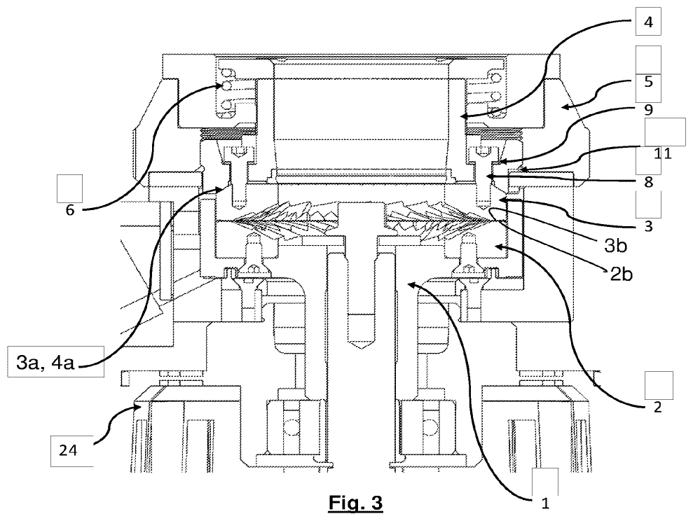

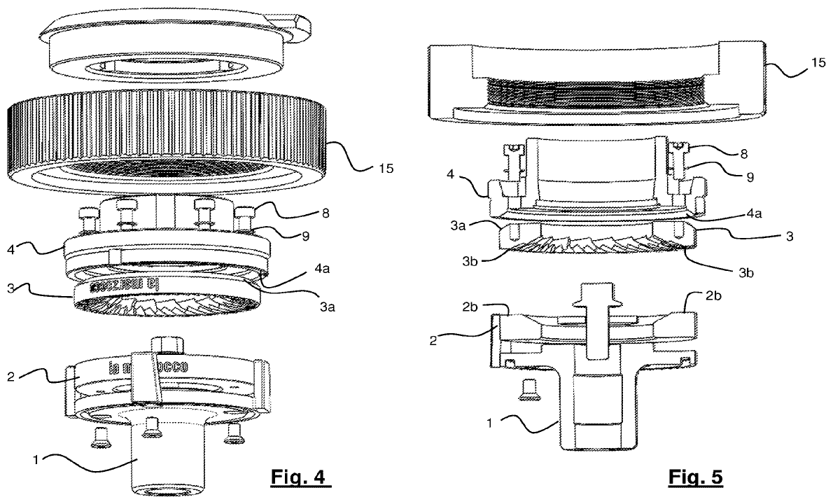

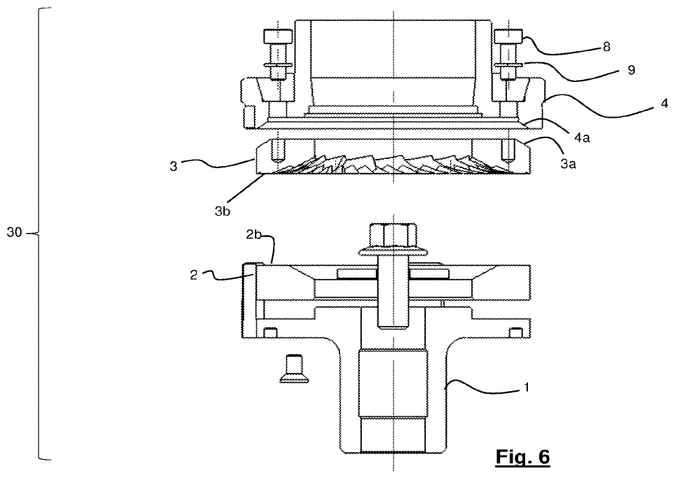

The burr assembly 30 is shown in greater detail in the various FIGS. 2-6.

The various FIGS. 2-6 also show the grinding chamber with the burr assembly 30, in turn comprising a lower burr 2 and an upper burr 3.

According to the embodiment shown, the lower burr 2 is the movable burr. It is kinematically connected to the motor shaft in any known manner. The connection may, for example, be performed by means of a grinder-holder flanged disc 1 which rotatably supports the lower burr 2.

Advantageously, the flanged disc 1 may be provided with suitable radial profiles 2a suitable for expelling the ground coffee out from the burrs 2, 3 of the grinding chamber.

It is clear that in the present description and in the associated drawings the arrangement of the axis A-A of the burrs 2, 3 is vertical. However, the present invention is applicable also to coffee grinding machined with a burr axis which is horizontal or differently inclined with respect to the vertical. In fact, as shown in FIG. 1.2, the axis A-A of the burrs is inclined with respect to the vertical. The burrs may also be arranged differently so as to have the movable burr at the top or so as to have two movable burrs.

The upper burr 3 is aligned on the same axis A-A. For the reasons mentioned above, the upper burr 3 must be perfectly parallel with the lower burr 2. The upper burr 3 is fixed to a threaded grinder-holder element 4 which, by means of the specially defined pitch and the ring nut 15, determines adjustment of the grinding via relative axial spacing of the burrs 2 and 3.

For the purposes of the present description and the claims, the expression “plane of a (flat) burr” or similar expressions will mean the plane defined when resting the burr on a horizontal surface. The plane of the burr also corresponds to the plane in which the external circumference of the outer rim of the burr lies, in the vicinity of the outlet.

For the purposes of the present description and the claims, the expression “aligning the burrs” will mean suitably orienting two flat burrs cooperating together, relative to each other, so that the plane of one burr is parallel to the plane of the other burr.

For the purposes of the present description and the claims, the expression “spherical surface” will indicate a surface which corresponds to a portion of a sphere. The expression will indicate both the concave sphere portion and the convex sphere portion.

For the purposes of the present description and the claims, the expression “conical surface” will indicate a surface which corresponds to a portion of a truncated cone.

The axial grinding adjustment is performed indirectly. Therefore, during adjustment, the threaded grinder-holder body 4 and the upper burr 3 fixed to it does not rotate by means of suitable radial locating elements 11, but is moved vertically by the rotation of the ring nut 15.

According to embodiments, the play resulting from engagement between the thread of the ring nut 15 and the grinder-holder element 4 is taken up by means of an axial spring 6, the thrusting action of which is in the direction of the grinding thrust.

In the known coffee grinding machines, the flat burrs are normally coupled to the grinder-holder element by means of the planar surface perpendicular to its axis.

According to the present invention, a configuration is provided where the fixed upper burr 3 is “floating” with respect to the grinder-holder body 4 before being firmly clamped to it. This function is ensured, according to one embodiment, by means of special spherical machining, i.e. a spherical surface 3a which extends along the outer edge of the fixed burr 3. This spherical surface 3a is configured to be coupled with a spherical seat 4a formed on the grinder-holder body 4.

The alignment (namely parallel arrangement) of the burrs 2, 3 is performed by bringing the two burrs into contact with each other via the adjustment ring nut 15. In other words, the fixed upper burr 3 is moved closer to the lower burr 2 until the planar surfaces 2b and 3b on the outer rim in the region of the undercut of the teeth are arranged perfectly aligned with each other. The floating coupling (before clamping) will be able to compensate for any alignment errors caused by the various components.

In this position where there is a substantially perfect parallel arrangement, the upper burr 3 is firmly fixed, for example by means of a series of screws 8 positioned in the region of the spherical coupling rim 3a.

According to embodiments, clamping is performed gradually. It is recommended that the screws 8 be mutually cross-tightened.

In order to compensate for any misalignment of a few microns underneath the head of the screws 8, elements which allow partial supporting of the screw, such as conical spring washers 9, may be used. For example, Schnorr® type safety washers may be used.

Once clamping has been completed, the upper burr 3 will be arranged perfectly parallel to the lower burr 2 and this condition will be maintained in any conditions of use and for any adjustment setting of the coffee grinding machine.

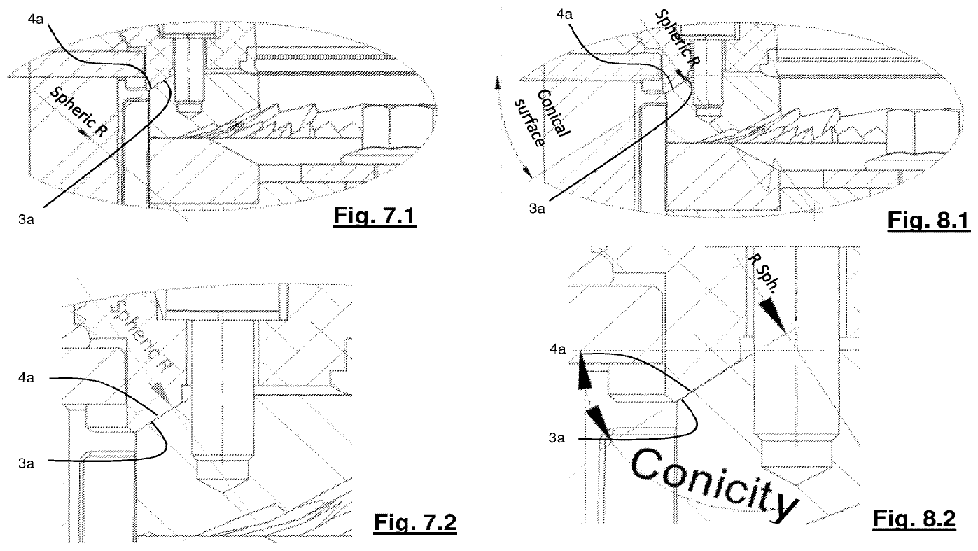

As will become clear, for auto-alignment (automatic parallel arrangement) of the burrs by means of the spherical coupling, two seats 3a and 4a, which are both spherical, are provided both on the upper burr 3 and on the grinder-holder body 4. This type of coupling is also shown in the larger-scale FIG. 7.1 and 7.2. The grinder holder 4 has a spherical surface 4a and the upper burr has a corresponding spherical surface 3a.

However, variants of this embodiment are possible. These variants are also shown in FIG. 8.1, 8.2, 9.1, 9.2 and 10.1, 10.2.

According to a first variant (FIG. 8.1 and 8.2) the upper burr 3 comprises a spherical contact surface 3a, while the surface 4a, directly facing the spherical contact surface 3a, comprises a conical surface.

Alternatively, according to a variant, the upper burr 3 comprises a conical surface 3a, while the surface 4a, directly facing the conical surface 3a, comprises a spherical contact surface.

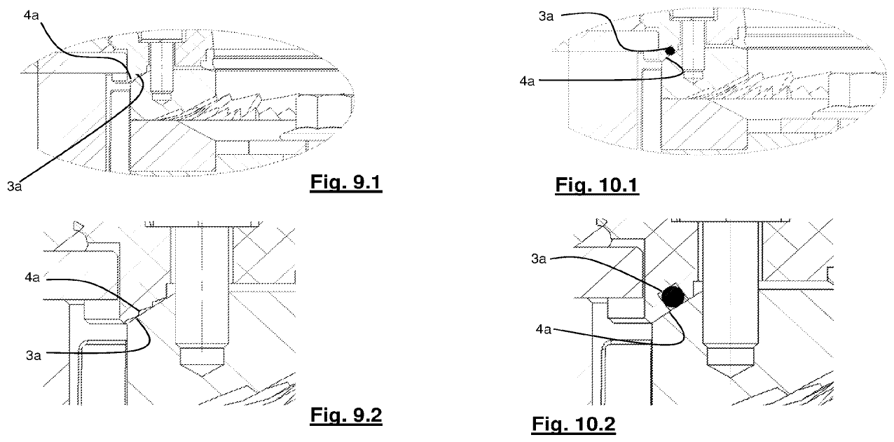

According to another variant (FIG. 9.1 and 9.2) the upper burr 3 comprises a spherical contact surface 3a, while the surface 4a, directly facing the spherical contact surface 3a, comprises a serrated surface with two or more grooves. In this case, the contact between the spherical contact surface 3a and the surface 4a occurs along one of the circumferences which correspond to a groove ridge.

According to another variant (substantially the opposite of that shown in FIG. 9.1 and 9.2), the upper burr 3 comprises a serrated surface 3a with two or more grooves, while the surface 4a, directly facing the serrated surface, comprises a spherical surface. In this case, the contact between the spherical contact surface 3a and the surface 4a occurs along one of the circumferences which correspond to a groove ridge.

According to another variant (FIG. 10.1 and 10.2), the upper burr 3 comprises a spherical contact surface 3a, while the surface 4a, directly facing the spherical contact surface 3a, comprises a preferably elastic, deformable body. For example, this may be an elastomer ring or the like partially inserted inside a corresponding seat. The elastomer ring could be designed to keep the burr in position following suitable pre-tensioning by means of the clamping screws.

Obviously, any reference made to relative positions, for example “upper burr” and “lower burr”, is not limiting for the purposes of the invention. In other words, the upper burr could be rotatable and the lower burr could be fixed, while remaining within the scope of protection of the invention.

1. A coffee grinding machine (10) with flat burrs, comprising:
a first burr (2);
a motor (24) configured to rotate the first burr (2) about a rotation axis (A-A);
a second burr (3) configured to cooperate with the first burr (2) for grinding coffee beans, wherein the second burr (3) comprises a second surface (3a);
a grinder-holder body (4) which can be locked to the second burr (3), wherein the grinder-holder body (4) comprises a first surface (4a) at least partially facing the second surface (3a) and cooperating therewith,
wherein either one of the first surface (4a) and the second surface (3a) is a spherical surface,
wherein the other one of the first surface (4a) and the second surface (3a) is a spherical surface, or comprises a conical surface, or comprises a serrated surface, or comprises a deformable element, and
wherein the first surface (4a) and the second surface (3a) cooperate with each other so as to suitably orient the first burr (2) with respect to the second burr (3) before locking the second burr (3) to the grinder-holder body (4).

2. The coffee grinding machine (10) of claim 1, wherein the second surface (3a) extends along the outer edge of the second burr (3).

3. The coffee grinding machine (10) of claim 1, or wherein the first surface is a spherical surface (4a) and the second surface is a spherical surface (3a) so that there is surface contact between the first surface and the second surface.

4. The coffee grinding machine (10) of claim 1, wherein the second surface (3a) is a spherical surface and the first surface is a conical surface (4a) or the second surface (3a) is a conical surface and the first surface is a spherical surface (4a), so that contact along a line is provided between the first surface and the second surface.

5. The coffee grinding machine (10) of claim 1, wherein the first surface is a first serrated surface (4a) and the second surface (3a) is a spherical surface, so that contact along one or more lines is provided between the first surface and the second surface.

6. The coffee grinding machine (10) of claim 1, wherein the first surface comprises a deformable element and the second surface is a spherical surface so that elastic contact is provided between the grinder-holder body (4) and the second burr (3).

7. The coffee grinding machine (10) of claim 1, wherein the grinder-holder body (4) can be releasably associated with the second burr (3) by means of connection members, for example clamping screws (8).

8. The coffee grinding machine (10) of claim 7, further comprising elements (9) which allow partial support of the connection members.

9. The coffee grinding machine (10) of claim 8, wherein said elements (9) comprise conical spring washers (9) or conical Schnorr® type safety washers.

10. A method for orienting relative to each other the burrs (2, 3) in a flat-burr coffee grinding machine, the method comprising:
providing a coffee grinding machine (10) comprising:
a first rotatable burr (2);
a second burr (3) which is configured to cooperate with the first burr (2) for grinding coffee beans, wherein the second burr (3) comprises a second surface (3a);
a grinder-holder body (4) which can be releasable associated with the second burr (3), wherein the grinder-holder body (4) comprises a first surface (4a) at least partially facing the second surface (3a) and cooperating therewith,
wherein either one of the first surface and the second surface (3a) is a spherical surface and wherein the other one of the first surface (4a) and the second surface (3a) is a spherical surface, or comprises a conical surface, or comprises a serrated surface, or comprises a deformable element,
orienting the second burr (3) with respect to the first burr (2) and
locking the second burr (3) to the grinder-holder body (4), wherein the orienting step comprises moving the second burr (3) and the grinder-holder body (4) relative to each other along the first surface and the second surface and the step for releasably associating them is performed after the orienting step.

11. The method of claim 10, wherein the second surface (3a) extends along the outer edge of the second burr (3).

12. The method of claim 10, wherein the orienting step comprises orienting the second burr (3) with respect to the first burr (2) so that the first burr (2) is parallel to the second burr (3).

13. The method of claim 10, wherein the facing curved surfaces comprise spherical surfaces.

14. The method according to claim 10, wherein the first burr (2) comprises a first planar surface (2b) on an outer rim thereof and the second burr (3) comprises a second planar surface (3b) on an outer rim thereof and wherein the orienting step comprises the step of bringing the second burr (3) closer to the first burr (2) until the first planar surface (2b) and the second planar surface (3b) are aligned with each other.

15. The method of claim 10, wherein the second burr (3) is releasably locked with the grinder-holder body (4) after the first planar surface (2a) and the second planar surface (3a) are arranged parallel to each other.

16. The method according to claim 10, wherein the second burr (3) is releasably locked to the grinder-holder body (4) by means of screws and, optionally, conical spring washers (9) or Schnorr® type safety washers.
